(19) United States
(12) Patent Application Publication
(10) Pub. No.: US 2019/0107093 A1
(43) Pub. Date: Apr. 11, 2019

(54) DECOUPLING ELEMENT FOR A FUEL INJECTION DEVICE

(71) Applicant: Robert Bosch GmbH, Stuttgart (DE)

(72) Inventors: Dietmar Schmieder, Markgroeningen (DE); Corren Heimgaertner, Schwieberdingen (DE)

(21) Appl. No.: 16/155,325

(22) Filed: Oct. 9, 2018

(30) Foreign Application Priority Data
Oct. 10, 2017 (DE) 102017218002.1

(51) Int. Cl. F02M 61/14; F02M 61/16

(52) U.S. Cl. CPC F02M 61/14; F02M 2200/09; F02M 2200/858; F02M 61/168

(57) ABSTRACT

A decoupling element for a fuel injection device is characterized in that a low-noise configuration is implemented. The fuel injection device includes at least one fuel injector and a receiving borehole in a cylinder head for the fuel injector and the decoupling element between a valve housing of the fuel injector and a wall of the receiving borehole. The decoupling element has a bowl- or cup-shaped configuration, and includes a radially inner contact area with which the decoupling element is radially inwardly placeable against the fuel injector. At least one further decoupling element is provided that has a bowl-shaped or cup-shaped configuration and is in direct contact with the other decoupling element. The fuel injection device is particularly suited for the direct injection of fuel into a combustion chamber of a mixture-compressing spark ignition internal combustion engine.

### RELATED APPLICATION INFORMATION

The present application claims priority to and the benefit of German patent application no. 10 2017 218 002.1, which was filed in Germany on Oct. 10, 2017, the disclosure of which is incorporated herein by reference.

### FIELD OF THE INVENTION

The present invention is directed to a decoupling element for a fuel injection device.

### BACKGROUND INFORMATION

FIG. 1 shows an example of a fuel injection device from the related art, in which a flat intermediate element is provided on a fuel injector that is installed in a receiving borehole of a cylinder head of an internal combustion engine. Such intermediate elements, as support elements in the form of a washer, are placed on a shoulder of the receiving borehole of the cylinder head in an understood manner. With the aid of such intermediate elements, manufacturing and installation tolerances are compensated for, and a bearing is ensured that is free of lateral forces, even when the fuel injector is slightly tilted.

The fuel injection device is particularly suited for use in fuel injection systems of mixture-compressing spark ignition internal combustion engines.

Another type of a simple intermediate element for a fuel injection device is discussed in DE 101 08 466 A1. The intermediate element is a washer, having a circular cross section, that is situated in an area in which the fuel injector as well as the wall of the receiving borehole extend in the cylinder head in the shape of a truncated cone, and that is used as a compensation element for bearing and supporting the fuel injector.

Intermediate elements for fuel injection devices that are more complicated and much more difficult to manufacture are discussed in DE 100 27 662 A1, DE 100 38 763 A1, and EP 1 223 337 A1, among others. These intermediate elements are characterized in that they all have a multi-part or multi-layer configuration, and are sometimes intended to take on sealing and damping functions. The intermediate element discussed in DE 100 27 662 A1 includes a base body and a support body in which a sealant, through which a nozzle body of the fuel injector extends, is inserted. A multi-layer compensation element is discussed in DE 100 38 763 A1 that is made up of two rigid rings and an elastic spacer ring situated in between in a sandwich-like manner. This compensation element allows tilting of the fuel injector with respect to the axis of the receiving borehole over a relatively large angular range, as well as radial displacement of the fuel injector from the center axis of the receiving borehole.

A likewise multi-layer intermediate element is also discussed in EP 1 223 337 A1, this intermediate element being made up of multiple washers made of a damping material. The damping material made of metal, rubber, or PTFE is selected and configured in such a way that noise damping of the vibrations and noise generated by operation of the fuel injector is made possible. However, for this purpose the intermediate element must include four to six layers in order to achieve a desired damping effect.

Damping elements in a disk shape for a fuel injector, in particular an injector for injecting diesel fuel in a common rail system, are also discussed in DE 10 2005 057 313 A1. The damping disks are intended to be inserted between the injector and the wall of the receiving borehole in the cylinder head in such a way that damping of structure-borne noise is made possible, even under high pressing forces, so that the noise emissions are reduced. The ring-shaped damping element rests with an annular face against the support surface of the cylinder head, and with a circumferential ridge rests against the conical support surface of the injector. However, this overall system has the disadvantage that the contact points of the damping element on the cylinder head and on the injector, viewed in the radial direction, are quite close to one another, and the damping element has a fairly stiff configuration due to its installation situation. As a result, clearly audible noise emissions are still present in this system.

In addition, U.S. Pat. No. 6,009,856 A refers to enclosing the fuel injector with a sleeve and filling the resulting space with an elastic, noise-damping compound to reduce noise emissions. However, this type of noise damping is very complicated, difficult to install, and costly.

### SUMMARY OF THE INVENTION

The decoupling element according to the present invention for a fuel injection device having the characterizing features described herein has the advantage that an improved reduction in noise is achieved, in a very simple configuration, by decoupling or insulating. According to the present invention, the decoupling element is formed from at least two bowl- or cup-shaped individual elements, in each case radially inner contact areas being provided via which the decoupling elements are radially inwardly placeable against the fuel injector and, at least indirectly, against a shoulder of the receiving borehole. The at least one further decoupling element likewise has a bowl- or cup-shaped configuration and is in direct contact with the other decoupling element. A firm connection of the decoupling elements is achieved in their radially outer contact areas. The radially inner contact areas of the decoupling elements have contact surfaces that directly or indirectly correspond to a convexly curved countersurface on the fuel injector or on the shoulder of the receiving borehole.

Further advantages of the arrangement according to the present invention are the defined axial rigidity with very low dispersion, and the axial support force that is free of lateral force. In addition, there is advantageously no excessively sharp-edged contact at the contact areas of the decoupling element.

Due to the shaping of the decoupling element according to the present invention and the dual configuration of the decoupling element, the tensile stresses and compressive stresses in the overall decoupling element in the installed state are minimized in a particularly advantageous manner.

Advantageous refinements and improvements of the fuel injection device described herein are possible as a result of the measures set forth in the further descriptions herein.

Ideally, each of the two radially inner contact surfaces of the decoupling element corresponds to a convex curvature of the countersurface, whose spherical radius has a midpoint situated approximately on the valve longitudinal axis of the fuel injector or the longitudinal axis of the receiving borehole of the cylinder head, which as a whole optimizes the reduction in the stresses, the noise decoupling, and the centered bearing of the decoupling element.

The decoupling element advantageously has an annular disk shape and an overall dual bowl- or cup-shaped configuration, and is manufactured as a stamped/bent part or as a turned part.

Depending on the use in an alternating pressure system or in a constant pressure system, the decoupling element is particularly advantageously configured with a nonlinear progressive spring characteristic or with a nonlinear degressive spring characteristic.

Exemplary embodiments of the present invention are illustrated in simplified form in the drawings, and explained in greater detail in the following description.

### BRIEF DESCRIPTION OF THE DRAWINGS

FIG. 1 shows a partial illustration of a fuel injection device in a particular configuration, including a disk-shaped intermediate element.

FIG. 2 shows a sectional illustration of a fuel injection device, including a first decoupling element according to the present invention.

FIG. 3 shows an enlarged detail III from FIG. 2 in a first installation situation of the decoupling element between the fuel injector and the cylinder head.

FIG. 3A shows a lock washer, as an individual part, that is used in the exemplary embodiment according to FIG. 3.

FIG. 4 shows an enlarged detail, analogous to FIG. 3, in a second embodiment according to the present invention, and the installation situation of the decoupling element between the fuel injector and the cylinder head.

FIG. 5 shows an enlarged detail, analogous to FIG. 3, in a third embodiment according to the present invention, and the installation situation of the decoupling element between the fuel injector and the cylinder head.

FIG. 6 shows an enlarged detail, analogous to FIG. 3, in a fourth embodiment according to the present invention, and the installation situation of the decoupling element between the fuel injector and the cylinder head.

FIG. 7 shows an enlarged detail, analogous to FIG. 3, in a fifth embodiment according to the present invention, and the installation situation of the decoupling element between the fuel injector and the cylinder head.

### DETAILED DESCRIPTION

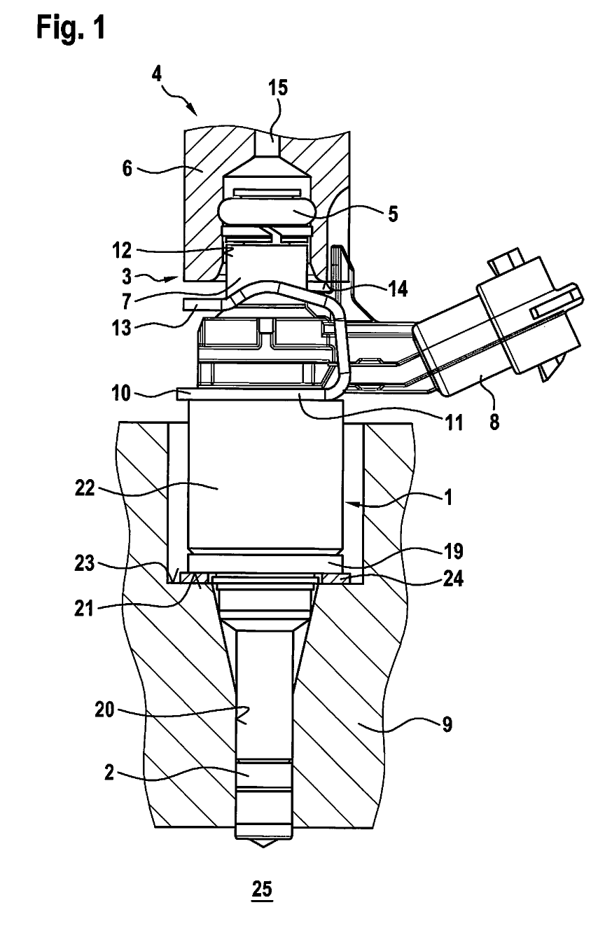

One specific embodiment of a fuel injection device, which is believed to be understood, is explained in greater detail below, with reference to FIG. 1, for an understanding of the present invention. FIG. 1 illustrates, as one exemplary embodiment, a side view of a valve in the form of an injector 1 for fuel injection systems of mixture-compressing spark ignition internal combustion engines. Fuel injector 1 is part of the fuel injection device. Fuel injector 1, which is configured in the form of a direct-injecting injector for direct injection of fuel into a combustion chamber 25 of the internal combustion engine, is installed with a downstream end into a receiving borehole 20 of a cylinder head 9. A sealing ring 2 made in particular of Teflon® ensures optimal sealing of fuel injector 1 with respect to the wall of receiving borehole 20 of cylinder head 9.

A flat intermediate element 24 configured in the form of a washer is inserted between a step 21 of a valve housing 22 (not shown) or a lower end-face side 21 of a support element 19 (FIG. 1) and a shoulder 23 of receiving borehole 20 that extends, for example, at a right angle to the longitudinal extension of receiving borehole 20. With the aid of such an intermediate element 24 or together with a rigid support element 19 having, for example, an inwardly arched contact surface with respect to fuel injector 1, manufacturing and installation tolerances are compensated for, and a bearing is ensured that is free of lateral forces, even when fuel injector 1 is slightly tilted.

Fuel injector 1 on its inflow-side end 3 includes a plug-in connection to a fuel distributor line (fuel rail) 4 that is sealed off by a sealing ring 5 between a connecting piece 6 of fuel distributor line 4, illustrated in a sectional view, and an inlet connector 7 of fuel injector 1. Fuel injector 1 is inserted into a receiving opening 12 of connecting piece 6 of fuel distributor line 4. Connecting piece 6 emerges in one piece, for example, from actual fuel distributor line 4, and upstream from receiving opening 12 has a flow opening 15 with a smaller diameter, via which the flow onto fuel injector 1 takes place. Fuel injector 1 includes an electrical connector plug 8 for the electrical contacting for actuating fuel injector 1.

A hold-down device 10 is provided between fuel injector 1 and connecting piece 6 in order to separate fuel injector 1 and fuel distributor line 4 from one another, largely free of radial force, and to securely hold down fuel injector 1 in the receiving borehole of the cylinder head. Hold-down device 10 is configured as a bow-shaped component, for example as a stamped/bent part. Hold-down device 10 includes a partial ring-shaped base element 11 from which a downwardly bent hold-down bracket 13 extends, which in the installed state rests against a downstream end face 14 of connecting piece 6 on fuel distributor line 4.

The object of the present invention is to achieve improved noise reduction, compared to the intermediate element, which is believed to be understood, and damping disk approaches, in a simple manner, in particular in the noise-critical no-load operation, but also in constant pressure systems at system pressure, via a targeted configuration and geometry of intermediate element 24. The forces introduced into cylinder head 9 during the valve operation (structure-borne noise), which result in a structural excitation of cylinder head 9 and which are emitted from same as airborne noise, are the primary noise source of fuel injector 1 during the direct high-pressure injection. To achieve an improvement in the noise level, the objective is therefore to minimize the forces that are introduced into cylinder head 9. In addition to reducing the forces caused by the injection, this may be achieved by influencing the transmission behavior between fuel injector 1 and cylinder head 9.

In addition, the aim is for decoupling element 240 to achieve its full function under actual installation conditions with as little stress as possible. Therefore, according to the present invention, a configuration and an installation situation of decoupling element 240 between fuel injector 1 and cylinder head 9 are selected which minimize the tensile stresses and compressive stresses in decoupling element 240.

According to the present invention, decoupling element 240 is characterized in that it is used for reducing the power flow between fuel injector 1 and its installation environment, with the objective of reducing undesirable noise excitation in the surrounding structure. In each case the advantageous features of the spring characteristic are included in the geometric configuration and material selection of decoupling element 240 in the specific embodiments of decoupling elements 240 described below.

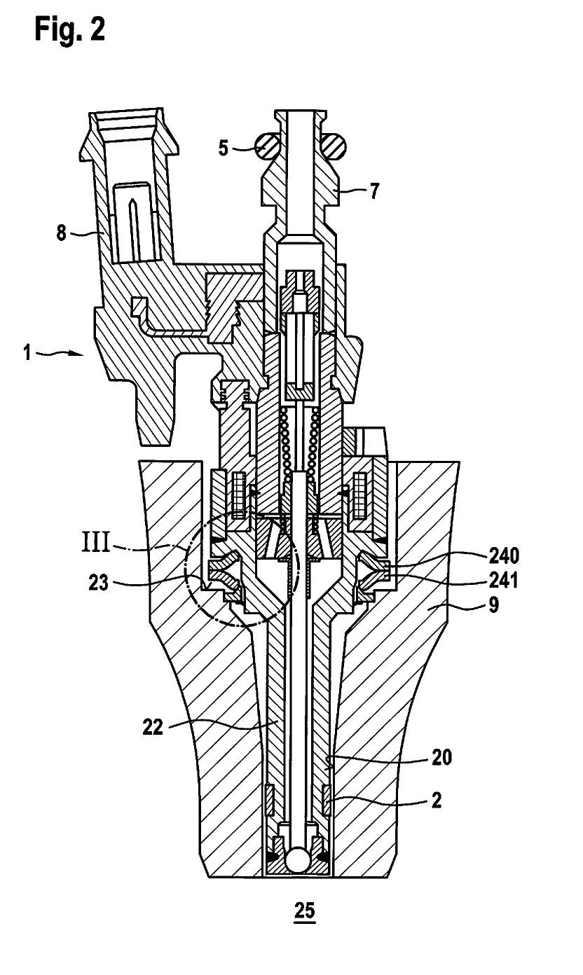

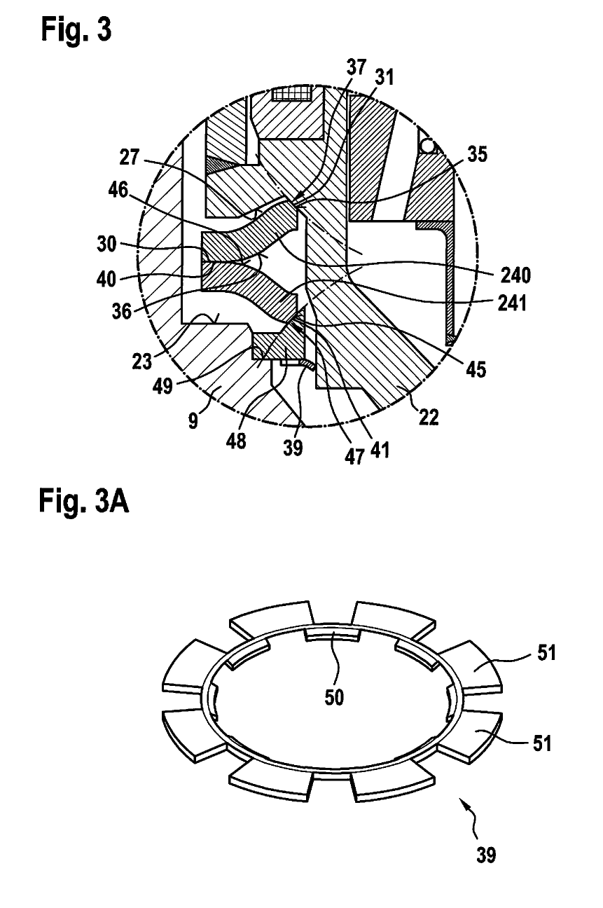

FIG. 2 shows a sectional illustration of a fuel injection device, including a first decoupling element 240, 241 according to the present invention, while FIG. 3 shows enlarged detail III from FIG. 2 in a first installation situation of decoupling element 240, 241 between fuel injector 1 and cylinder head 9. This embodiment of the fuel injection device involves a system for direct gasoline injection via fuel injectors 1, which, as shown, are operated with an electromagnetic actuator, or also with piezo actuators, and used in a constant pressure system, for example. Decoupling element 240, 241 is advantageously configured as a multipart metallic perforated disk that extends in a ring shape. A metallic material is also suitable due to the fact that it is machinable using cost-effective manufacturing methods (turning, deep drawing, for example) to allow dimensionally accurate production of the desired geometries of decoupling element 240, 241. In particular, it is suitable to manufacture decoupling element 240, 241 as a stamped/bent part. One example of a possible material for decoupling element 240, 241 is austenitic stainless steel 1.4310 (X10CrNi18-8), which has very good formability.

Decoupling element 240, 241 has a multipart configuration according to the present invention, a first decoupling element 240 having a bowl- or cup-shaped configuration, and at least one further, second decoupling element 241 likewise having a bowl- or cup-shaped configuration. Ideally, both decoupling elements 240, 241 have the same shape and size, and in the installed state face one another axially. First decoupling element 240 includes a radially inner contact area 31 with which decoupling element 240 is radially inwardly placeable against fuel injector 1, while second decoupling element 241 includes a radially inner contact area 41 with which decoupling element 241 may, at least indirectly, rest radially inwardly against a shoulder 23 of receiving borehole 20. First and second decoupling elements 240, 241 are in direct contact with one another.

In the installed state, each decoupling element 240, 241, in addition to radially inner contact areas 31, 41, also includes a radially outer contact area 30, 40. The two decoupling elements 240, 241 rest against one another at outer contact areas 30, 40, and together form an overall decoupling element. With inner contact area 31, first decoupling element 240 is supported on valve housing 22 of fuel injector 1 in a ring shape. For this purpose, valve housing 22 includes, for example, a tapering, beveled housing section 27 which to a certain extent radially inwardly follows the course of decoupling element 240. The installation of decoupling element 240 is thus simplified.

Also according to the present invention, decoupling element 240 is characterized in that radially inner contact area 31 of decoupling element 240 has a contact surface 35 that corresponds to a convexly curved countersurface 37 on fuel injector 1. Tapering, beveled housing section 27 of valve housing 22 ends radially inwardly in a recess-like manner, and from this area then merges directly into convex countersurface 37. Convexly curved countersurface 37 on fuel injector 1 is advantageously formed with a constant spherical radius. The midpoint of the imaginary sphere on which countersurface 37 extends is ideally situated approximately on the valve longitudinal axis of fuel injector 1. In other words, with spherically convex countersurface 37 on radially inner contact area 31, a spherical segment of valve housing 22 annularly and circumferentially spans a full 360° about a sphere midpoint situated approximately on the valve longitudinal axis of fuel injector 1.

Contact surface 35 in radially inner contact area 31 of decoupling element 240 may have a relatively sharp-edged configuration, which has the disadvantage of increased compressive stresses in decoupling element 240. For this reason it is advantageous to likewise round contact surface 35, in particular with a very small radius, resulting in an essentially linear contact of decoupling element 240 on countersurface 37 of valve housing 22.

Likewise spherically convex contact surface 36 in radially outer contact area 30 of decoupling element 240 has either a rounded configuration with a constant radius, or a crowned, spherically curved, or convex configuration with a nonconstant radius. The radius contact surface 36 of radially outer contact area 30 may be selected to be much larger than the radius of spherical countersurface 37 of valve housing 22, which in turn has a much larger radius than that of contact surface 35 in radially inner contact area 31, as the result of which the fatigue strength-determining tensile stresses in the outer area of decoupling element 240 may be reduced.

In principle, second decoupling element 241 is situated opposite from first decoupling element 240, axially facing same, in the installed state. Thus, in the installed state, decoupling element 241 once again includes two support or contact areas 40, 41, radially outer contact area 40 and radially inner contact area 41. Decoupling element 241 with outer contact area 40 rests against outer contact area 30 of first decoupling element 240. Decoupling element 241 with inner contact area 41 is supported, at least indirectly, in a ring shape on shoulder 23 of receiving borehole 20 in cylinder head 9. However, shoulder 23 of receiving borehole 20 now has a convexly curved countersurface 47. In the exemplary embodiment according to FIG. 3, convexly curved countersurface 47 is formed on a separate support disk 48, which in turn ultimately rests on a step 49 of receiving borehole 20 of cylinder head 9.

Second decoupling element 241 is once again characterized in that radially inner contact area 41 of decoupling element 241 has a contact surface 45 that corresponds to a convexly curved countersurface 47 on cylinder head 9. Step 49, on which support disk 48 with specially configured, convexly curved countersurface 47 fixedly rests, radially inwardly adjoins shoulder 23, which extends flatly and at a right angle with respect to the valve longitudinal axis of fuel injector 1. Convexly curved countersurface 47 on support disk 48 is advantageously formed with a constant spherical radius. Ideally, the midpoint of the imaginary sphere on which countersurface 47 extends is situated approximately on the valve longitudinal axis of fuel injector 1 or on the longitudinal axis of receiving borehole 20. In other words, with spherically convex countersurface 47 on radially inner contact area 41, a spherical segment of cylinder head 9 annularly and circumferentially spans a full 360° about a sphere midpoint situated approximately on the longitudinal axis of receiving borehole 20.

Prior to installation, a lock washer 39 that is pressed onto or integrally joined to valve housing 22, beneath support disk 48, is provided to captively secure support disk 48, and ultimately entire decoupling element 240, 241, on fuel injector 1. Prior to installation of fuel injector 1 in receiving borehole 20 of cylinder head 9, the entire assembly made up of decoupling elements 240, 241 and support disk 48 is preassembled on fuel injector 1 and secured via lock washer 39.

In the preassembled state, the two decoupling elements 240, 241 are thus already fixedly connected to one another, in particular at the two radially outer contact areas 30, 40, by a weld seam or multiple weld or tack points with the aid of soldering, gluing, or other joining methods.

FIG. 3A illustrates a lock washer 39, as an individual part, that is used in the exemplary embodiment according to FIG. 3. Lock washer 39 includes multiple detent lugs 50, distributed radially inwardly over the circumference, for example, that are used for securing to fuel injector 1, while multiple radially outwardly protruding support segments 51, distributed over the circumference, are formed for support disk 48. Detent lugs 50 plastically deform when pressed on, and dig in on valve housing 22.

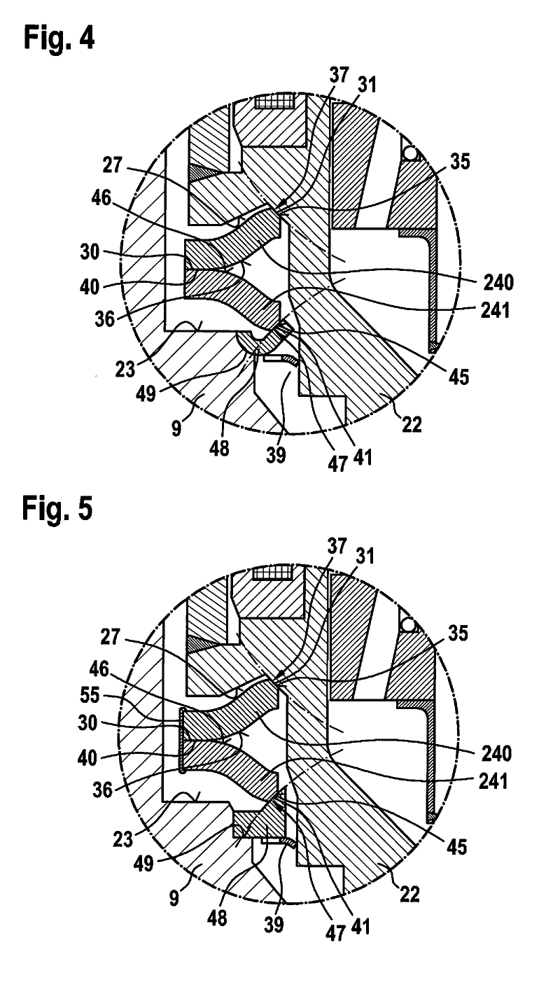

FIG. 4 shows an enlarged detail, analogous to FIG. 3, in a second embodiment according to the present invention, and the installation situation of decoupling element 240, 241 between fuel injector 1 and cylinder head 9. In this exemplary embodiment, support disk 48 is configured as a corrugated stamped/bent part having a hook-shaped cross section, which is once again supported on a step 49 of shoulder 23 or of receiving borehole 20, which may be rounded, and is engaged from beneath by lock washer 39. Support disk 48 once again has a convexly curved countersurface 47 that corresponds to contact surface 45 of decoupling element 241.

FIG. 5 shows an enlarged detail, analogous to FIG. 3, in a third embodiment according to the present invention, and the installation situation of decoupling element 240, 241 between fuel injector 1 and cylinder head 9. From the configuration of decoupling elements 240, 241, the embodiment shown corresponds to the approach already shown in FIG. 3. Instead of an integral bond, the two decoupling elements 240, 241 are fixedly connected to one another by a centering ring 55, mounted on the radially outer circumference, which circumferentially clasps decoupling elements 240, 241. One possible material for centering ring 55 is stainless austenitic steel 1.4310 (X10CrNi18-8), for example. By use of centering ring 55, the radial play of the combination of decoupling elements 240, 241 may advantageously be set to a minimum.

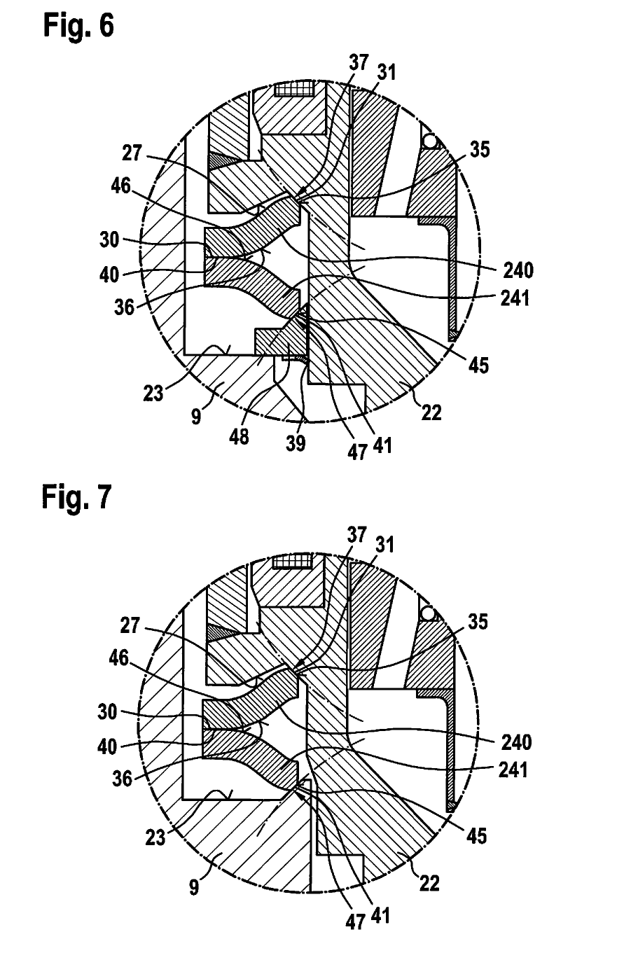

FIG. 6 shows an enlarged detail, analogous to FIG. 3, in a fourth embodiment according to the present invention, and the installation situation of decoupling element 240, 241 between fuel injector 1 and cylinder head 9. From the configuration of decoupling elements 240, 241, the embodiment shown corresponds to the approach already shown in FIG. 3. However, support disk 48 no longer rests on a step 49, but, rather, rests directly on shoulder 23 of receiving borehole 20. In this regard, complicated machining of the wall of receiving borehole 20 may be dispensed with here. However, support disk 48 is precisely machined at its radially inner diameter, since it must be radially guided on the circumferential surface of valve housing 22. Support disk 48 once again has a convexly curved countersurface 47 that corresponds to contact surface 45 of decoupling element 241.

FIG. 7 shows an enlarged detail, analogous to FIG. 3, in a fifth embodiment according to the present invention, and the installation situation of decoupling element 240, 241 between fuel injector 1 and cylinder head 9. From the configuration of decoupling elements 240, 241, the embodiment shown corresponds to the approach already shown in FIG. 3. However, this approach dispenses with a support disk 48 altogether. Instead, shoulder 23 of receiving borehole 20 itself is machined in such a way that a convexly curved countersurface 47 is provided that corresponds to contact surface 45 of decoupling element 241. Specially configured, convexly curved countersurface 47, as part of shoulder 23, radially inwardly directly adjoins shoulder 23, which extends flatly and at a right angle with respect to the valve longitudinal axis of fuel injector 1. Convexly curved countersurface 47 on cylinder head 9 is advantageously formed with a constant spherical radius. The midpoint of the imaginary sphere on which countersurface 47 extends is ideally situated approximately on the valve longitudinal axis of fuel injector 1 or on the longitudinal axis of receiving borehole 20.

What is claimed is:

1. A decoupling element for a fuel injection device for a fuel injection system of an internal combustion engine, comprising:
a decoupling device having a bowl-shaped configuration or a cup-shaped configuration, wherein the fuel injection device includes at least one fuel injector and a receiving borehole for the fuel injector, and the decoupling device is introduced between a valve housing of the fuel injector and a wall of the receiving borehole;
wherein the decoupling device has a radially inner contact area with which the decoupling device is radially inwardly placeable against the fuel injector or a shoulder of the receiving borehole, and
wherein at least one further decoupling device is provided that has a bowl-shaped configuration or a cup-shaped configuration and is in direct contact with the decoupling device.

2. The decoupling element of claim 1, wherein the radially inner contact area of the one decoupling device includes a contact surface that corresponds to a convexly curved countersurface on the fuel injector, and a radially inner contact area of the further decoupling device includes a contact surface that cooperates, at least indirectly, with a convexly curved countersurface on the shoulder of the receiving borehole.

3. The decoupling element of claim 2, wherein the convexly curved countersurfaces on the fuel injector or on the shoulder of the receiving borehole are formed with a constant spherical radius.

4. The decoupling element of claim 3, wherein a midpoint of an imaginary sphere on which the countersurface extends is situated approximately on a valve longitudinal axis of the fuel injector or a longitudinal axis of the receiving borehole.

5. The decoupling element of claim 2, wherein the convexly curved countersurfaces that circumferentially extend a full 360° are configured as spherical segments.

6. The decoupling element of claim 1, wherein the decoupling devices each include radially outer contact areas that rest against one another, and at which the decoupling devices are connected to one another.

7. The decoupling element of claim 6, wherein the radially outer contact areas of the decoupling device each have a spherically convex contact surface whose curvature is configured with a radius that is larger than the radius of the contact surface of the radially inner contact area.

8. The decoupling element of claim 1, wherein the convexly curved countersurface is configured to contact the further decoupling device on a support disk that rests in the receiving borehole.

9. The decoupling element of claim 1, wherein a lever arm between the two radial positions of the contact surfaces of the decoupling device remains constant during operation.

10. The decoupling element of claim 1, wherein the decoupling device is manufacturable as a stamped/bent part or a turned part.

11. The decoupling element of claim 1, wherein the fuel injection device is for direct injection of fuel into a combustion chamber.
